(19) United States
(12) Patent Application Publication
(10) Pub. No.: US 2005/0123472 A1
(43) Pub. Date: Jun. 9, 2005

(54) Hydrogen production

(76) Inventors: Stephen Ivor Hall, Oxfordshire (GB); Anthony Robert Martin, Oxfordshire (GB); Michael Joseph Bowe, Lancashire (GB)

Correspondence Address: LAW OFFICES OF WILLIAM H. HOLT, 12311 HARBOR DRIVE, WOODBRIDGE, VA, 22192, US

(21) Appl. No.: 10/507,590

(22) PCT Filed: Mar. 7, 2003
(86) PCT No.: PCT/GB03/00978

(30) Foreign Application Priority Data
Mar. 13, 2002 (GB) 0205837.8
Jul. 4, 2002 (GB) 0215414.4

(51) Int. Cl. H01M 8/06; H01M 8/18; C01B 3/26

(52) U.S. Cl. 423/651; 429/19

(57) ABSTRACT

Hydrogen is produced from a hydrocarbon fuel such as diesel, the process comprising: subjecting a mixture of the fuel with oxygen gas to plasma treatment in a dielectric barrier plasma reactor to generate oxygenated molecules; mixing the resulting oxygenated molecules with steam and subjecting them to steam reforming in a compact catalytic reactor at elevated temperature, and then to a water gas shift reaction (possibly with additional steam) at an elevated temperature. The resulting gases may then be mixed with a small quantity of oxygen gas, and subjected to selective oxidation to convert any carbon monoxide to carbon dioxide. This process avoids diluting the gases with nitrogen from the atmosphere, and can achieve very high yields. The hydrogen may be subsequently used in a fuel cell to generate electricity. Such a process may be used at an offshore facility.

The present invention relates to a process and an apparatus for producing hydrogen from a hydrocarbon, for example a long chain hydrocarbon.

Fuels cells consuming hydrogen and oxygen (from the air) offer the promise of providing a clean electrical power source. However this leads to a requirement for an efficient and correspondingly clean process for the production of hydrogen. It would be convenient if this could be produced from hydrocarbons that are currently widely available, for example through the existing distribution network for petrol or diesel for internal combustion engines.

Another situation in which conversion of hydrocarbons to hydrogen would be beneficial is in floating production, storage and offloading vessels used at remote locations for processing products from oil or gas wells. It may not be economic to pipe the natural gas ashore, and conversion of short chain hydrocarbons to longer chains in situ is not thermodynamically efficient, if these are to be converted back to CO₂ and H₂ onshore.

The present invention accordingly provides a process for producing hydrogen from a hydrocarbon fuel, the process comprising:

(a) combining the fuel in vapour or gaseous form with oxygen gas; and passing the resulting mixture through a dielectric barrier plasma reactor to generate oxygenated molecules; and

(b) then combining the gases containing oxygenated molecules with steam; and subjecting this mixture to steam reforming by passage through a compact catalytic reactor defining flow channels containing catalysts for steam reforming, and also defining flow channels in good thermal contact therewith containing a source of heat such that the reforming step occurs at a temperature in the range 550 to 850° C.

Preferably the steam reforming step is performed at a pressure below 10 atmospheres (1 MPa), and may be performed at approximately atmospheric pressure. Preferably the process also comprises: (c) then combining the gases produced by steam reforming with additional steam; and subjecting this mixture to a water gas shift reaction by passage through a compact catalytic reactor defining flow channels containing catalysts for the water gas shift reaction, and also defining flow channels in good thermal contact therewith containing a source of heat such that the water gas shift reaction step occurs at a temperature in the range 500 to 700° C.

If this third step c) is included, the process forms a gas stream consisting almost exclusively of hydrogen and carbon dioxide. Any traces of carbon monoxide that remain can be removed by then combining the gas stream with a small quantity of oxygen gas, and subjecting the mixture to a selective oxidation reaction in the presence of a catalyst, such that any carbon monoxide is oxidised to carbon dioxide.

Preferably the sources of heat for the steam reforming and for the water gas shift reaction are provided by catalytic combustion in the corresponding flow channels. The combustion may involve reaction of hydrocarbon fuel with air.

The oxygen gas may be supplied in any convenient manner, for example as bottled gas, but is preferably generated as required, for example by electrolysis of water. A benefit of using oxygen in step (a) rather than air, is that air contains about 80% nitrogen which would not react, and would significantly dilute the product gases.

The hydrogen/carbon dioxide mixture may be supplied to a proton exchange membrane fuel cell to generate electricity, the cell also being supplied with air. Some of the electricity may be used to electrolyse water in order to generate the oxygen gas required in step (a) of the above process, and in the selective oxidation reaction. Such electrolysis also generates hydrogen, which can be fed back into the fuel cell. The exhaust gases from the fuel cell consist of carbon dioxide and water vapour, and may be cooled, and at least some of the water condensed to provide water for electrolysis and to supply water for the steam required in step (b) and step (c).

Alternatively the hydrogen gas may be separated from the carbon dioxide, for example using a platinum or palladium membrane, or a palladium/copper membrane, so as to generate hydrogen gas as a product or for use in a fuel cell. Indeed, if such a membrane is used, the mixture of gases generated by the steam reforming step may be provided directly to the hydrogen-permeable membrane, so as to generate a stream of pure hydrogen, and a tail gas mixture which contains carbon monoxide and methane in addition to carbon dioxide. This tail gas may be used as fuel in a catalytic combustion channel.

The invention also provides an apparatus for performing the method.

For the oxidation reaction (catalytic combustion) several different catalysts may be used, for example palladium, platinum or copper on a ceramic support; for example copper or platinum on an alumina support stabilised with lanthanum, cerium or barium, or palladium on zirconia, or more preferably palladium or palladium/platinum on an alumina support. For the reforming reaction also several different catalysts may be used, for example nickel, platinum, palladium, ruthenium or rhodium, which may be used on ceramic coatings; the preferred catalyst for the reforming reaction is rhodium or platinum on alumina or stabilised alumina. The oxidation reaction may be carried out at substantially atmospheric pressure, and the steam reforming reaction is preferably also carried out at atmospheric pressure, although it may be carried out at somewhat elevated pressure.

It will be appreciated that the materials of which the reactor are made are subjected to a severely corrosive atmosphere in use, for example the temperature may be as high as 900° C., although more typically around 850° C. The reactor may be made of a metal such as an aluminium-bearing ferritic steel, in particular of the type known as Fecralloy (trade mark) which is iron with up to 20% chromium, 0.5-12% aluminium, and 0.1-3% yttrium. For example it might comprise iron with 15% chromium, 4% aluminium, and 0.3% yttrium. When this metal is heated in air it forms an adherent oxide coating of alumina which protects the alloy against further oxidation; this oxide layer also protects the alloy against corrosion under conditions that prevail within for example a methane oxidation reactor or a steam/methane reforming reactor. Where this metal is used as a catalyst substrate, and is coated with a ceramic layer into which a catalyst material is incorporated, the alumina oxide layer on the metal is believed to bind with the oxide coating, so ensuring the catalytic material adheres to the metal substrate.

The invention will now be further and more particularly described, by way of example only, and with reference to the accompanying drawings in which:

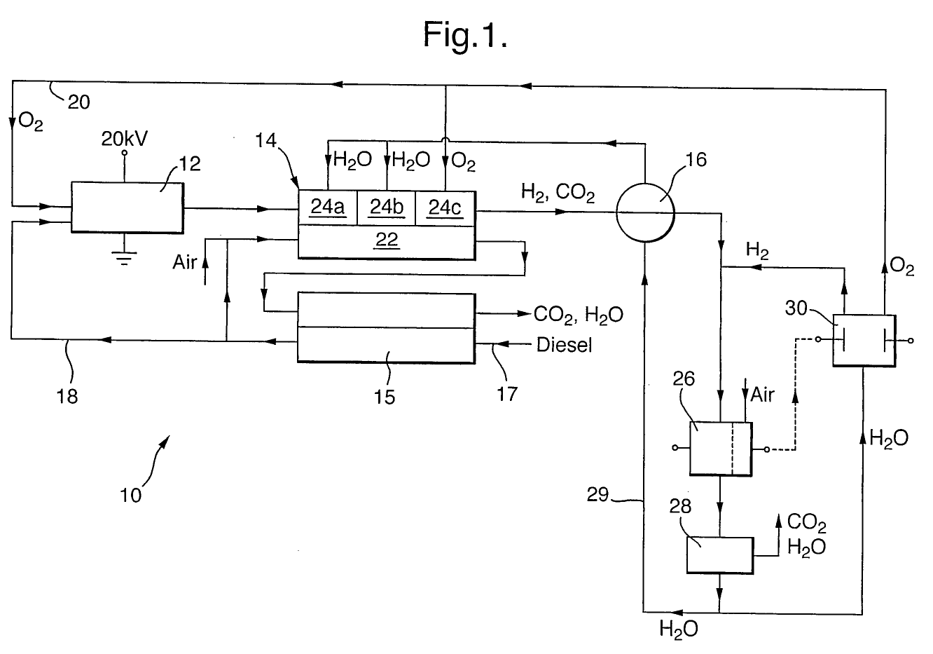

FIG. 1 shows a flow diagram of a plant and process of the invention;

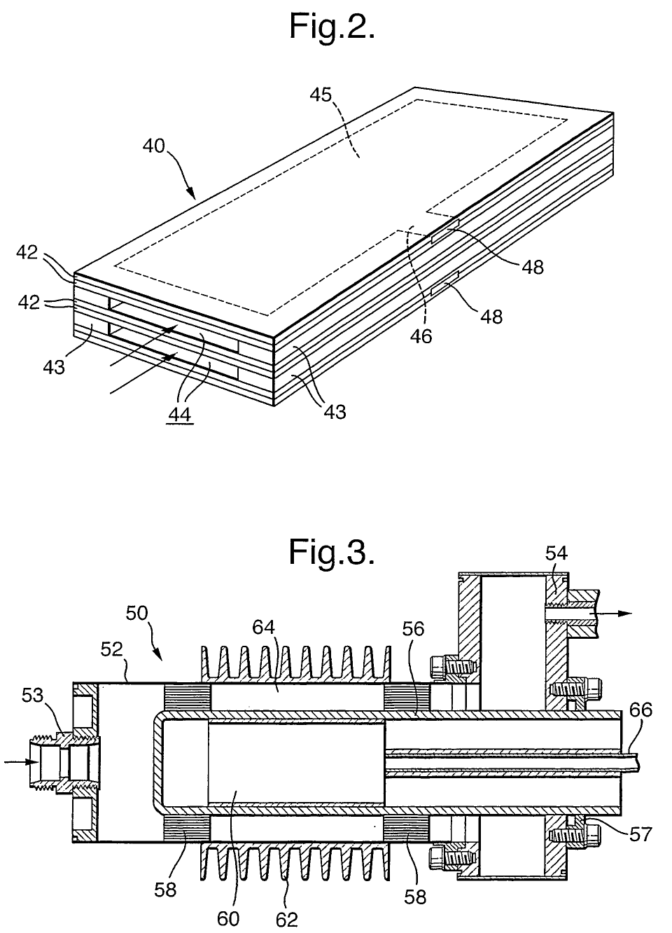

FIG. 2 shows a perspective view of a dielectric barrier plasma reactor suitable for use in plant for performing the process of FIG. 1;

FIG. 3 shows a longitudinal sectional view of an alternative dielectric barrier plasma reactor suitable for use in such a plant;

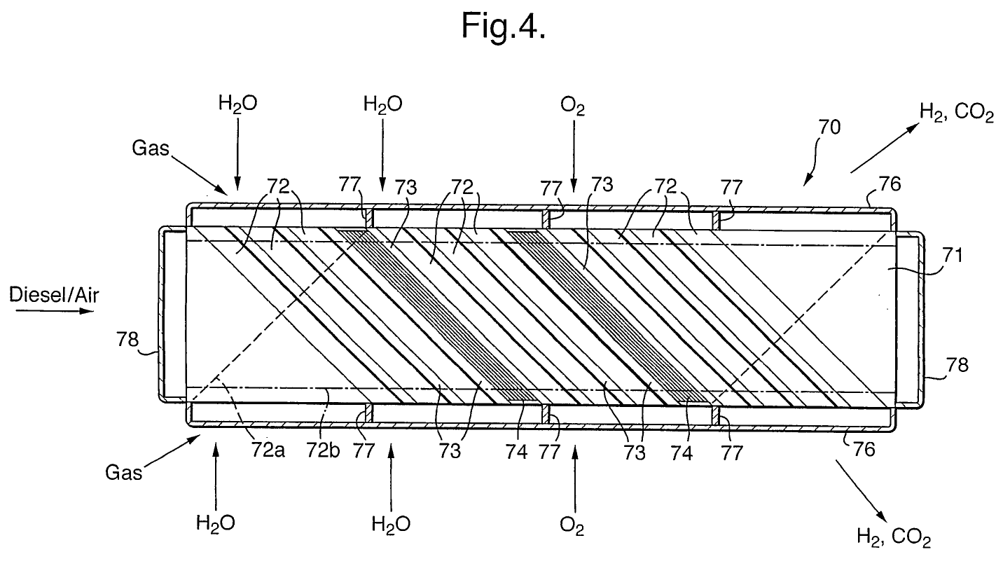

FIG. 4 shows a sectional view of a catalytic reactor suitable for use in plant for performing the process of FIG. 1; and

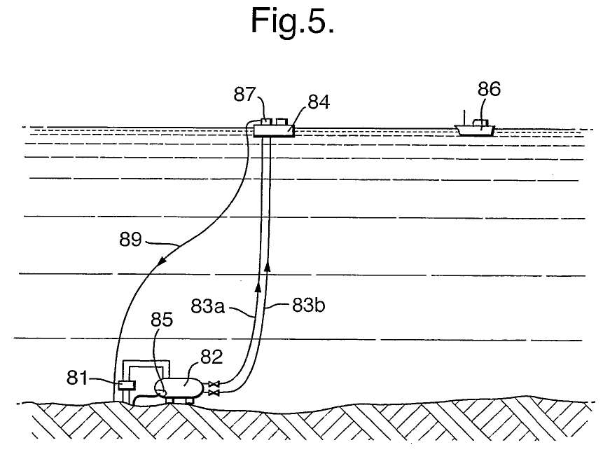

FIG. 5 shows a diagrammatic view of an offshore production facility.

Referring now to FIG. 1, a flow diagram is shown for generating electricity from diesel fuel. The plant 10 to perform this process includes a dielectric barrier plasma reactor 12 and a compact catalytic reactor 14 in which heat is generated by combustion. Hot gases from the reactor 14 flow through compact heat exchangers 15 and 16 in which the heat is used to vaporise diesel fuel and water respectively. Diesel fuel is supplied via a pipe 17 to the heat exchanger 15, part of the diesel vapour being combined with air and fed to the reactor 15 (for combustion), and part of the diesel vapour is supplied via a pipe 18 to the inlet of the plasma reactor 12. Oxygen gas is also provided to the inlet of the plasma reactor 12 via a pipe 20. The plasma environment is such as to optimize the production of reactive oxygen atoms, which react with carbon-carbon bonds of the hydrocarbon, breaking the larger molecules into smaller oxygenated molecules, typically C1 to C4.

The catalytic reactor 14 comprises a stack of plates with grooves that define flow channels. Successive plates in the stack provide channels for the reacting gases produced by the plasma reactor 12, and for combustion, alternately. The combustion channels 22 contain a platinum combustion catalyst. The reaction channels 24 subject the reacting gases to three successive reactions, in the presence of three successive catalysts, and appropriate reactants are added in corresponding stages along the channels: in the first stage 24a steam is mixed with the reacting gases, and steam reforming takes place; in the second stage 24b, more steam is added, and a water gas shift reaction occurs; in the third stage 24c, a small amount of oxygen is added, and selective oxidation of carbon monoxide to carbon dioxide occurs. The first stage 24a is at a temperature in the range 750 to 850° C., the second stage 24b is at a temperature in the range 550 to 650° C., and the third stage 24c is at about 350° C. The steam supplied to the first two stages 24a and 24b is generated by the heat exchanger 16.

The oxygenated hydrocarbon molecules generated by the plasma reactor 12 react with steam in stage 24a to generate hydrogen and carbon monoxide, for example:
C₂H₅OH+H₂O-->2CO+4H₂
which is endothermic. This reforming process preferably takes place in a residence time less than 0.1 s, with a catalyst of rhodium and platinum on alumina. The water gas shift reaction in stage 24b is as follows:
CO+H₂O-->CO₂+H₂
and is exothermic. The catalyst for this reaction may also be rhodium/platinum on alumina, or may be iron oxide/chromium oxide. The selective oxidation, stage 24c, may use a catalyst of ruthenium on porous alumina, or alternatively it may use tin oxide (which may be made from a metastannic acid sol as described in U.S. Pat. No. 4,946,820), or platinum-doped tin oxide for example 0.1 parts by weight of platinum to 1 part of tin oxide and 10 parts of alumina. The gas emerging from the reaction channels 24 of the reactor 14 (and supplying heat to the water in the heat exchanger 16) therefore consists almost exclusively of hydrogen and carbon dioxide.

The mixture of hydrogen and carbon dioxide is then supplied to a proton exchange membrane fuel cell 26 to which air is also supplied, which therefore generates electricity. The gas stream therefore then consists of carbon dioxide and water vapour, and this is passed through a condenser 28 to generate water. The resulting stream of water may be supplied via a duct 29 to the heat exchanger 16, and hence to the reactor 14. Some of the water is supplied to an electrolysis cell 30 (which may be supplied with electricity by the fuel cell 26, as indicated diagrammatically by a broken line), to generate oxygen gas and hydrogen gas. The oxygen gas is supplied via the duct 20 to the third stage 24c of the reactor 14, and to the plasma reactor 12. The hydrogen gas may be fed back into the fuel cell 26.

Referring now to FIG. 2, a non-thermal dielectric barrier plasma reactor 40 is shown that would be suitable for use as the plasma reactor 12. This comprises a stack of rectangular plates 42 of a dielectric material such as alumina. The plates 42 are arranged in pairs, and spacer strips 43 of the same dielectric material are positioned between successive pairs of plates 42 along opposite sides of the stack so as to define gas flow channels 44 that extend through the stack. A rectangular layer 45 of an electrical conductor such as a metal (which may for example be formed by a screen printing) is sandwiched between the plates 42 of each pair, and is smaller than the plates 42 so that a 20 mm wide margin is left around it; this conducting layer has an integral narrow projecting tab 46 that extends to the edge at one side. The plates 42 of each pair are bonded together by a glaze around the periphery of the conducting layer, so that the conducting layer is completely encapsulated within dielectric material (apart from the projecting tabs 46). In assembling the stack the pairs are arranged so that the tabs 46 in successive pairs extend to opposite sides of the stack, where they are provided with electrical contacts 48. For example the plates 42 may be of thickness 1 mm, and the ceramic spacer strips 43 might be of thickness in the range 1.5 to 3.0 mm. Only three pairs of plates 42 (and two flow channels 44) are shown in the figure, but in practice the stack might consist of a much larger number. In any event there should be an odd number of pairs, so the top and bottom pairs in the stack are of the same polarity, so both can be earthed.

In use of the reactor 40 the mixture of diesel vapour and oxygen flows along the channels 44, while a high voltage alternating signal is applied between the conducting layers 45 above and below each channel 44. For example the signal might be in the range 5-30 kV, for example 20 kV, and might be supplied at 1 kHz; this signal would be applied to the terminals 48 on one side of the stack, while the terminals on the other side would all be earthed.

Referring now to FIG. 3 an alternative dielectric barrier plasma reactor 50 is shown in section. The reactor 50 includes a stainless-steel tubular housing 52 with an inlet duct 53 at one end, and connected to a transverse outlet duct 54 at the other end. A ceramic tube 56 of alumina, closed at one end, is supported by a mounting flange 57 on the outlet duct 54, so that the tube 56 extends within and coaxial with the housing 52. The tube 56 is also supported by two ceramic rings 58 defining a multiplicity of axial ducts, the rings 58 locating between the tube 56 and the inside of the housing 52. A tubular electrode 60 is mounted on the inner surface of the tube 56, along the section between the support rings 58. A copper tube 62 defining cooling fins fits tightly around the housing 52 along that same section. The annular gap 64 between the tube 56 and the housing 52 may be filled with a permeable packing of elements of a high permittivity material such as alumina or barium titanate.

In use of the reactor 60 the mixture of diesel vapour and oxygen flows through the inlet duct 53 and is diverted by the closed end of the ceramic tube 56 to flow through the first ceramic ring 58, along the annular gap 64, and then through the second ceramic ring 58. The resulting gases emerge through the transverse outlet duct 54. The housing 52 is earthed, while a high voltage alternating signal is supplied via a lead 66 to the tubular electrode 60, so that a strong electric field is applied across the annular gap 64 through which the gases are flowing.

Referring now to FIG. 4, a catalytic reactor 70 suitable for use as the reactor 14 (and which if not provided with catalyst could also be used for the heat exchangers 15 and 16), comprises a stack of Fecralloy steel plates 71, each plate being generally rectangular, 650 mm long and 150 mm wide and 3 mm thick. On the upper surface of each such plate 71 are rectangular grooves 72 of depth 2 mm separated by lands 73 (twelve such grooves being shown), but there are three different arrangements of the grooves 72. In the plate 71 shown in the drawing the grooves 72 extend diagonally at an angle of 45° to the longitudinal axis of the plate 71, from top left to bottom right as shown. In a second type of plate 71 the grooves 72a (as indicated by broken lines) follow a mirror image pattern, extending diagonally at 45° from bottom left to top right as shown. In a third type of plate 71 the grooves 72b (as indicated by chain dotted lines) extend parallel to the longitudinal axis.

The plates 71 are assembled in a stack, with each of the third type of plate 71 (with the longitudinal grooves 72b) being between a plate with diagonal grooves 72 and a plate with mirror image diagonal grooves 72a, and after assembling many plates 71 the stack is completed with a blank rectangular plate. The plates 71 are compressed together during diffusion bonding, so they are sealed to each other. Corrugated Fecralloy alloy foils 74 (only two are shown) of appropriate shapes and with corrugations 2 mm high, can be slid into each such groove 72, 72a and 72b. Each such foil 74 is coated with a ceramic such as alumina, and with a catalyst material.

Header chambers 76 are welded to the stack along each side, each header 76 defining four compartments by virtue of three fins 77 that are also welded to the stack. The fins 77 are one quarter of the way along the length of the stack from each end, and coincide with a land 73 (or a portion of the plates with no groove) in each plate 71 with diagonal grooves 72 or 72a. Gas flow headers 78 in the form of rectangular caps are then welded onto the stack at each end, communicating with the longitudinal grooves 71b. In a modification (not shown), in place of each three-compartment header 76 there might instead be three adjacent header chambers, each being a rectangular cap like the headers 78.

In use of the reactor 70, diesel vapour and air are supplied to the header 78 at one end (the left hand end as shown), and the resulting exhaust gases emerge through the header 78 at the other end. The gases emerging from the plasma reactor 12 and steam are both supplied to the compartments of both headers 76 at the same end (the left hand end as shown), and the catalyst on the foils 74 communicating with those header compartments are catalysts for steam reforming. More steam is added to the second headers 76, where it mixes with the gases that have undergone steam reforming. The catalyst on the foils 74 in the next set of channels 72 is the catalyst for the shift reaction. Oxygen is introduced into the third compartments of the headers 78, and the catalyst on the foils 74 in the next set of channels 72 is the catalyst for the selective oxidation reaction. Hence the gases emerging from the last header compartment, as discussed above, are hydrogen and carbon dioxide. The level of carbon monoxide should be less than 10 ppm.

If the catalysts becomes spent, they can be replaced by cutting off the headers 76 and 78, and then extracting the foils 74 from all the channels defined by the grooves 72, and replacing the foils 74. The headers 76 and 78 can then be re-attached. Alternatively the headers may be merely bolted on to the stack.

It will be appreciated that although the channels 72 are all shown as being of the same width, alternatively the channels 72 may be of different widths at different positions along the sheet 71 in accordance with which stage 24a, b, or c they correspond to. And similarly the corrugations of the foils 74 may be different for the different stages 24a, b and c. It will also be appreciated that the plates 71 might be longer, for example requiring the gas to traverse four diagonal passageways or grooves 72, 72a to go from the inlet compartments to the outlet compartments. In this case, for example, the first two diagonal passageways might be used for steam reforming, the third being used for the shift reaction and the last for selective oxidation. The diagonal passageways or grooves 72, 72a might have a different orientation, for example they might be at 60° to the longitudinal axis of the sheets 71.

It will also be appreciated that instead of adding steam to both the first two stages 24a and 24b, an excess of steam may instead be provided to just the first stage 24a. It will also be understood that a different hydrocarbon fuel such as gasoline may be used in place of diesel.

The plant 10 might be sufficiently small to be used as the power supply on a vehicle, the electricity being stored in batteries and used to drive the vehicle with electric motors. The plant 10 is sufficiently compact that it may be installed for example on an oil rig or on a floating oil production structure, and the reaction processes are not affected by wave motion. Thus the system might be supplied with natural gas rather than diesel, so as to generate electricity. The electricity might be supplied to market using a power cable, or alternatively the electricity could be employed to charge an array of containerised high-energy capacity light weight storage batteries, the batteries being carried by a shuttle vessel to market and employed for example to power electric vehicles. Alternatively the mixture of hydrogen and carbon dioxide might be processed using a hydrogen-permeable membrane to obtain pure hydrogen gas, which might be stored for example using a cryogenic carbon adsorption process.

Referring to FIG. 5, a sea bed wellhead 81 supplies a mixture of oil, gas and produced water to a sea bed separator unit 82. The separator unit 82 separates the three fluids, and supplies the oil and gas to risers 83a and 83b that lead to a floating production platform 84. A high-pressure pump 85 incorporated within the separator unit 82 enables the produced water to be re-injected into the well. The production platform 84 stores the oil in storage tanks, to be taken ashore by a transport vessel 86. The production platform 84 also incorporates a plant 87 to convert the natural gas to hydrogen and carbon dioxide, including a pump to inject the carbon dioxide into a porous rock formation (for example a depleted hydrocarbon reservoir) via a pipe 89. The natural gas is primarily methane, but with small proportions of slightly longer-chain hydrocarbons such as ethane, ethene and propane.

The plant 87 may comprise several features which are the same as those of the plant 10 of FIG. 1, differing in that it is supplied with natural gas rather than diesel as the hydrocarbon fuel. As with the plant 10, the natural gas is preheated in the heat exchanger 15, mixed with oxygen and then passed through a dielectric barrier plasma reactor 12, and then subjected to steam reforming 24a in the reactor 14. It may also be subjected to the water gas shift reaction 24b and a catalytic oxidation stage 24c. The hydrogen gas may be separated from the other gaseous components (primarily carbon dioxide) using a hydrogen-selective membrane, and this hydrogen may then be stored and subsequently transferred ashore in the vessel 86. Alternatively the hydrogen obtained in this fashion may be utilised in a fuel cell to generate electricity. If there is such a fuel cell, the combustion channel 22 may also be supplied with combustible gas mixed with oxygen from the electrolysis cell 30 (rather than air), so that the waste gases consist only of carbon dioxide and water. The electricity may be transmitted to shore by a cable, or alternatively may be used to charge accumulators such as lithium ion batteries, which may for example be carried in the vessel 86. In either case this would provide a clean source of electricity, with all the carbon dioxide being injected. If an alkaline fuel cell is used for generating electricity, it is generally necessary to first separate the hydrogen from the carbon dioxide, while with other types of fuel cell, such as the proton exchange membrane fuel cell 26, the gas mixture may be supplied directly to the fuel cell, as in the plant 10.

In a further modification the gas mixture from the plasma treatment is subjected only to steam reforming 24a in such a reactor 14. This reaction may for example be carried out at a pressure of 7 atmospheres. The gas mixture is then supplied directly to a hydrogen permeable membrane. The bulk of the hydrogen is thereby separated from the remaining tail gas, which consists of carbon monoxide, carbon dioxide and methane. Typically the proportions of carbon monoxide and carbon dioxide in this tail gas are 70% and 20% respectively, the other gases being methane and residual hydrogen in approximately equal quantities. This tail gas may be supplied as fuel (mixed with oxygen generated by electrolysis) into the combustion channels 22 of the reactor 14, so that the gases remaining after combustion are only carbon dioxide and water. The carbon dioxide can be compressed, and reinjected through the pipe 89.

1. A process for producing hydrogen from a hydrocarbon fuel, the process comprising:
(a) combining the fuel in vapour or gaseous form with oxygen gas; and passing the resulting mixture through a dielectric barrier plasma reactor to generate oxygenated molecules; and
(b) then combining the gases containing oxygenated molecules with steam; and subjecting this mixture to steam reforming by passage through a compact catalytic reactor defining flow channels containing a catalyst for steam reforming, and also defining flow channels in good thermal contact therewith containing a source of heat such that the reforming step occurs at a temperature in the range 550 to 850° C.

2. A process as claimed in claim 1 also comprising:
(c) then combining the gases produced by steam reforming with additional steam; and subjecting this mixture to a water gas shift reaction by passage through a compact catalytic reactor defining flow channels containing a catalyst for the water gas shift reaction.

3. A process as claimed in claim 2 wherein the reactor for the water gas shift reaction also defines flow channels in good thermal contact therewith that contain a source of heat such that the water gas shift reaction occurs at a temperature in the range 500 to 700° C.

4. A process as claimed in claim 2 wherein the resulting gases are then combined with a small quantity of oxygen gas, and the mixture subjected to a selective oxidation reaction in the presence of a catalyst, such that any traces of carbon monoxide are oxidised to carbon dioxide.

5. A process as claimed in claim 1 wherein the source of heat for the endothermic reactions is provided by catalytic combustion in the corresponding flow channels.

6. A process as claimed in claim 1 wherein the oxygen gas required in stage (a) is provided by electrolysis of water.

7. A process as claimed in claim 1 wherein hydrogen is separated from other product gases using a hydrogen-permeable membrane.

8. A method of processing a hydrocarbon at an offshore site, the method comprising producing hydrogen and carbon dioxide from the hydrocarbon by a process as claimed in claim 1, and injecting the carbon dioxide into porous rock formations below the sea bed.

9. An apparatus for producing hydrogen from a hydrocarbon fuel by a process as claimed in claim 1.

10. An apparatus for processing a hydrocarbon at an offshore site, the apparatus comprising apparatus for producing hydrogen as claimed in claim 9, and means for injecting carbon dioxide into porous rock formations below the sea bed.

11. An apparatus as claimed in claim 9, also comprising a fuel cell for generating electricity.
